(19) United States
(12) Patent Application Publication
(10) Pub. No.: US 2003/0184671 A1
(43) Pub. Date: Oct. 2, 2003

(54) Glare reduction system for image capture devices

(76) Inventors: Mark N. Robins, Greeley, CO (US); Heather N. Bean, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 10/112,339

(22) Filed: Mar. 28, 2002

(51) Int. Cl. H04N 5/235

(52) U.S. Cl. 348/362

(57) ABSTRACT

An image capture system is designed with the capability of recording multiple images at varying exposures. Areas of saturation within the final exposure are determined, and color channel ratios are calculated from underexposed images and used to set pixels within the areas of saturation to maximum magnitude while retaining the color channel ratios of the corresponding pixels within the underexposed images.

### FIELD OF THE INVENTION

The present invention is related to the field of image capture devices and more specifically to the field of glare reduction within image capture devices.

### BACKGROUND OF THE INVENTION

Many current image capture devices use charge coupled devices (CCDs) to electronically record light intensity and color forming a digital image of a subject. CCDs are only able to record up to a finite intensity of light and any additional light falling on the CCD does not add to the charge stored in the CCD. When read this CCD will show maximum intensity. This condition is called saturation. When multiple elements or pixels within a CCD reach saturation within an image, details of the image may be lost since all of the saturated elements or pixels contain the same intensity and color data: pure white at maximum intensity.

Saturation of a portion of the CCD may be due to a camera flash reflecting from a surface, or simply sunlight reflecting from a surface. Proper exposure of the rest of the image may require that some portion of the CCD saturate. In many cases this glare within the image is unwanted and detracts from the image.

### SUMMARY OF THE INVENTION

An image capture system is designed with the capability of recording multiple images at varying exposures. Areas of saturation within the final exposure are determined, and color channel ratios are calculated from underexposed images and used to set pixels within the areas of saturation to maximum magnitude while retaining the color channel ratios of the corresponding pixels within the underexposed images.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1 illustrates three different exposures by a single CCD array in an example embodiment of the present invention.

FIG. 2 illustrates three different exposures by a single CCD array along with a graph of the three exposures in time in an example embodiment of the present invention.

FIG. 3 is an example embodiment of an image capture device according to the present invention.

FIG. 4 is a flowchart of an example embodiment of a method for reducing glare according to the present invention.

FIG. 5 is a flowchart of an example embodiment of a method for reducing glare according to the present invention.

FIG. 6 is a flowchart of an example embodiment of a method for reducing glare according to the present invention.

FIG. 7 is a flowchart of an example embodiment of a method for reducing glare according to the present invention.

FIG. 8 is a flowchart of an example embodiment of a method for reducing glare according to the present invention.

FIG. 9 is a flowchart of an example embodiment of a method for reducing glare according to the present invention.

FIG. 10 is an example calculation of a maximum color magnitude while retaining color channel ratios in an example embodiment of the present invention.

### DETAILED DESCRIPTION

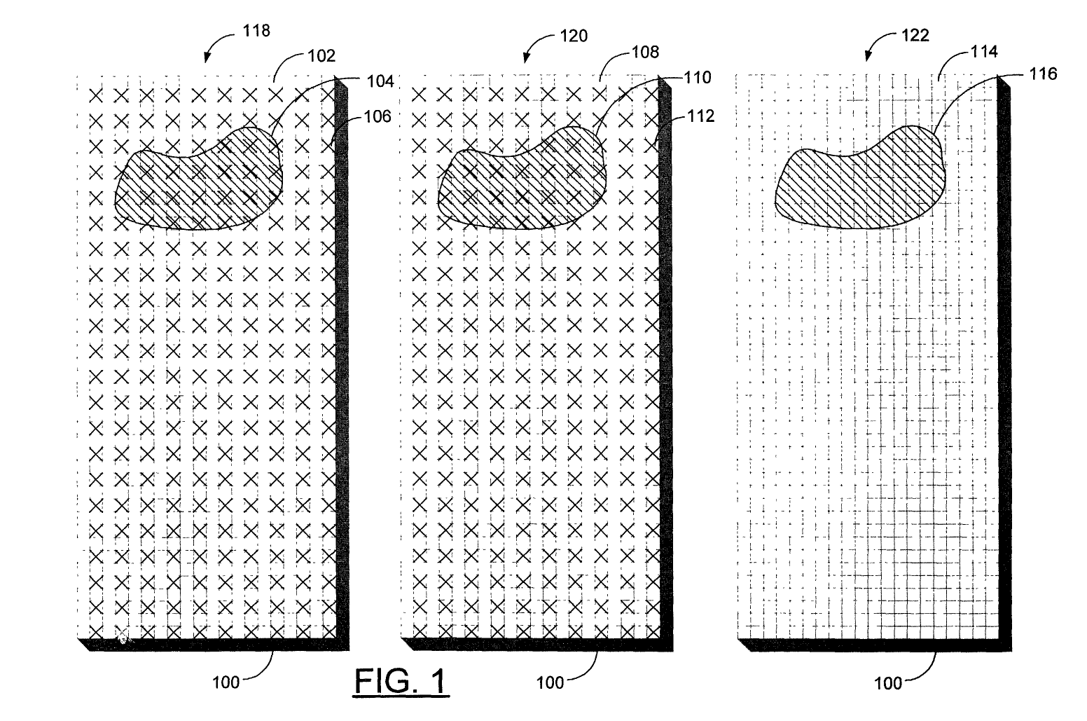

FIG. 1 illustrates three different exposures by a single CCD array in an example embodiment of the present invention. A CCD array 100 of size 20 pixels by 44 pixels in an example embodiment of the present invention is exposed to an image at three different exposures.

In a normal exposure 122, all of the pixels 114 required to achieve the desired image resolution are selected, and the normal image is recorded in memory within the image capture device. Any saturated CCDs within the normal image are detected. In an example embodiment of the present invention, an area of saturation 116 is shown within the normal exposure 122. In the example embodiment of the present invention shown in FIG. 1, only one area of saturation 116 is shown for simplicity. However, in actual use, a plurality of areas of saturation may exist and the method of the present invention may be applied to any or all of them.

In a first exposure 118 a portion of the 880 pixels of the array are read into a memory. This first exposure 118 is underexposed relative to the normal exposure 122. In this example embodiment of the present invention, a fraction of the pixels from the normal exposure are selected for use. Selected pixels 106 are represented by an ‘X’ in the diagram while unselected pixels 102 are left blank. A saturation area 104 within the first exposure 118, corresponding to the area of saturation 116 in the normal exposure 122 is represented by a cross-hatched shape. By purposely underexposing the first exposure 118, the pixels within the saturation area 104 may be unsaturated. Thus, the unsaturated pixels in this saturation area 104 show the color of the portion of the image that was saturated in the normal exposure 122. This underexposure may be created by firing a flash at an intensity less than that required for a normal exposure, or by adjusting the aperture or exposure time of the image capture device to create an underexposure. In the example embodiment of the present invention shown in FIG. 1, only one-fourth of the pixels within the CCD array 100 are read for the first underexposed image. In other embodiments within the scope of the present invention different quantities and locations of pixels may be read for the first underexposed image. In some embodiments of the present invention, capture speed and memory may be sufficient to allow the first exposure 118 to record image data for all of the pixels within the CCD array 100 instead of sampling a subset of the pixels within the CCD array 100.

If desired, in a second exposure 120, a fraction of the 880 pixels of the CCD array 100 are read into a memory. Selected pixels 112 are represented by an ‘X’ in the diagram while unselected pixels 108 are left blank. Note that while the example embodiment of the present invention shown in FIG. 1 has the same pixels selected in the first exposure 118 and the second exposure 120 other embodiments may use different pixels for the first and second exposures within the scope of the present invention. A saturation area 110 within the second exposure 120, corresponding to the area of saturation 116 in the normal exposure 122 is represented by a cross-hatched shape. The second exposure 120 is taken as an underexposed image at a different exposure than the first exposure 118. If the first exposure 118 contained some saturated pixels, a second exposure 120 may be taken as an even greater underexposure in an attempt to capture color data from the pixels within the saturation area 110. This underexposure may be created by firing a flash at an intensity less than that required for a normal exposure, or by adjusting the aperture or exposure time of the image capture device to create an underexposure. In the example embodiment of the present invention shown in FIG. 1, only one-fourth of the pixels within the CCD array 100 are read for the first underexposed image. In other embodiments within the scope of the present invention different quantities and locations of pixels may be read for the second underexposed image. In some embodiments of the present invention, capture speed and memory may be sufficient to allow the second exposure 120 to record image data for all of the pixels within the CCD array 100 instead of sampling a subset of the pixels within the CCD array 100. Also note that while the example embodiment of the present invention illustrated in FIG. 1 includes a first exposure 118 and a second exposure 120, other embodiments within the scope of the present invention may include a different number of underexposed images. In some embodiments of the present invention, a single underexposure may be taken, while in other embodiments of the present invention, three or more underexposures may be taken.

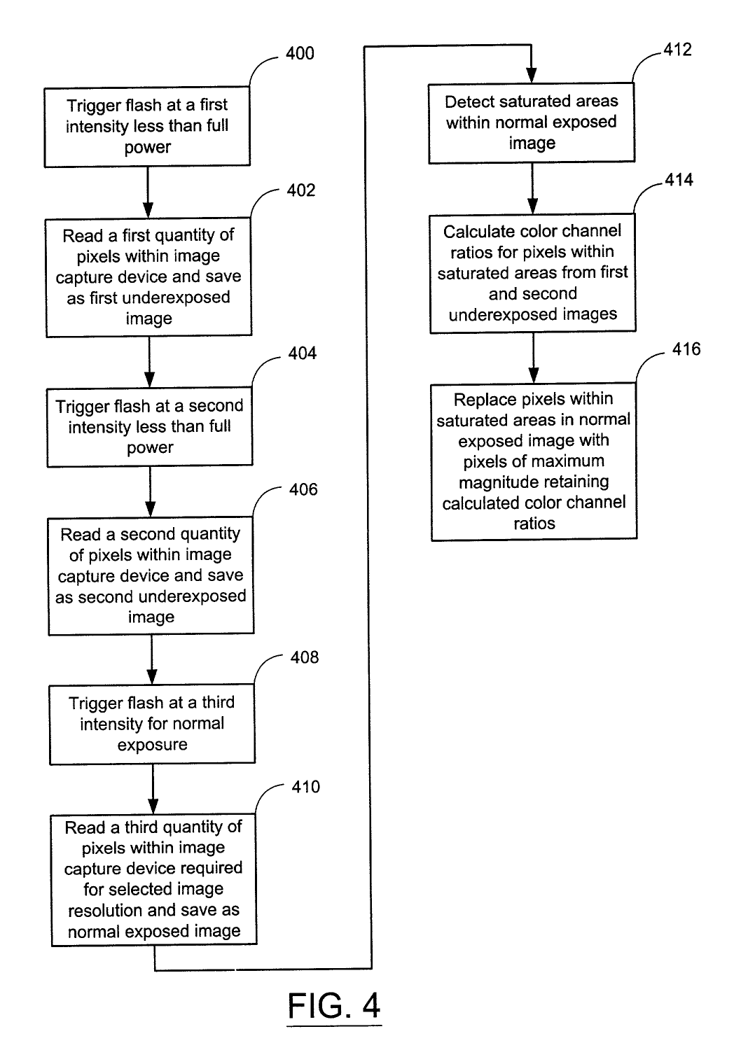

After the underexposure or underexposures are captured, the color of the pixels within the area of saturation 116 may be calculated from the pixels in the underexposed images. The area of saturation 116 within the normal image may then be color corrected by a process similar to those shown in FIGS. 4 through 9 within the scope of the present invention.

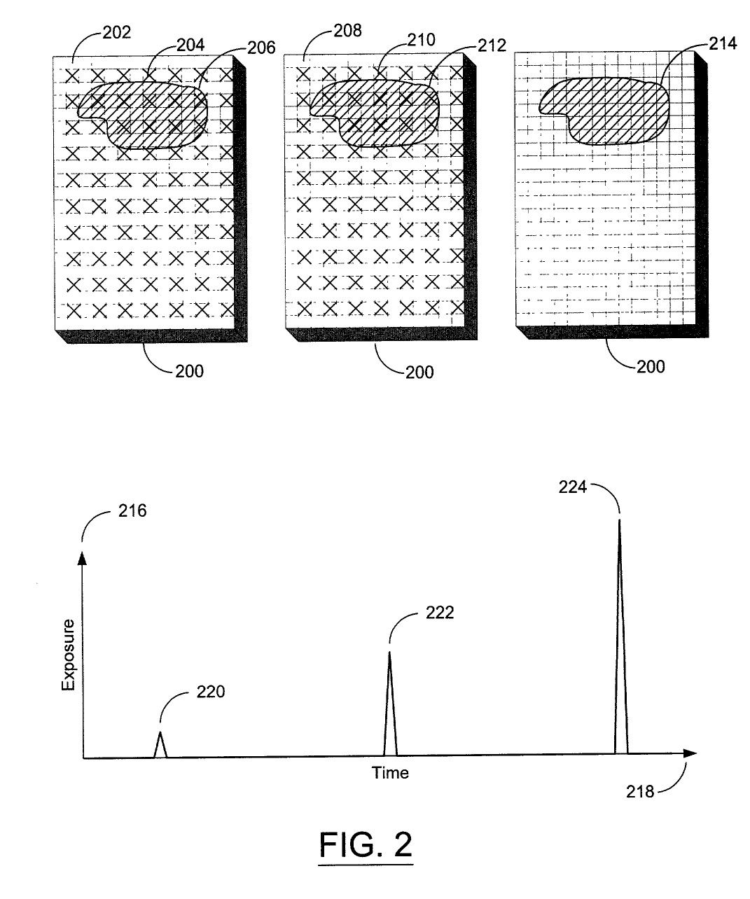

FIG. 2 illustrates three different exposures by a single CCD array along with a graph of the three exposures in time in an example embodiment of the present invention.

In FIG. 2 exposure 216 is shown along the Y-axis and time 218 is shown along the X-axis. At a time 220 a first underexposure is made. In this first underexposure a fraction of the pixels of the CCD array 200 are read into a memory. Selected pixels 204 are represented by an ‘X’ in the diagram while unselected pixels 202 are left blank. A saturation area 206 within the first underexposure corresponding to an area of saturation 214 within the normal exposure at time 224 is represented by a cross-hatched shape.

Optionally, at a time 222 a second underexposure is made. In this second underexposure a portion of the pixels of the CCD array 200 are read into a memory. Selected pixels 210 are represented by an ‘X’ in the diagram while unselected pixels 208 are left blank. Note that while the example embodiment of the present invention shown in FIG. 2 has the same pixels selected in the first underexposure at time 220 and the second underexposure at time 222, other embodiments may use different pixels for the first and second underexposures within the scope of the present invention. A saturation area 212 within the second underexposure corresponding to an area of saturation 214 within the normal exposure at time 224 is represented by a cross-hatched shape.

At a time 224 a normal exposure is made. All of the pixels required to achieve the desired image resolution are selected, and the normal image is recorded in memory within the image capture device. An area of saturation 214 is shown within the normal exposure at time 224. This are of saturation 214 within the normal image may then be color corrected by a process similar to those shown in FIGS. 4 through 9 within the scope of the present invention.

In the exposure versus time chart, exposure is represented by the vertical axis. The exposures at times 220, 222, and 224 are shown as peaks with differing heights. The first underexposure, at time 220 in this example embodiment of the present invention, is shown by a very small peak representing a severe underexposure. Underexposures may be created by shortening the exposure time or by reducing the aperture of the image capture device, thus allowing less light to reach the CCD. The second underexposure, at time 222 in this example embodiment of the present invention, is shown by a medium sized peak representing a medium underexposure. Once again, this underexposure may be created by shortening the exposure time or reducing the aperture of the image capture device with respect to the exposure time and aperture of a normal exposure.

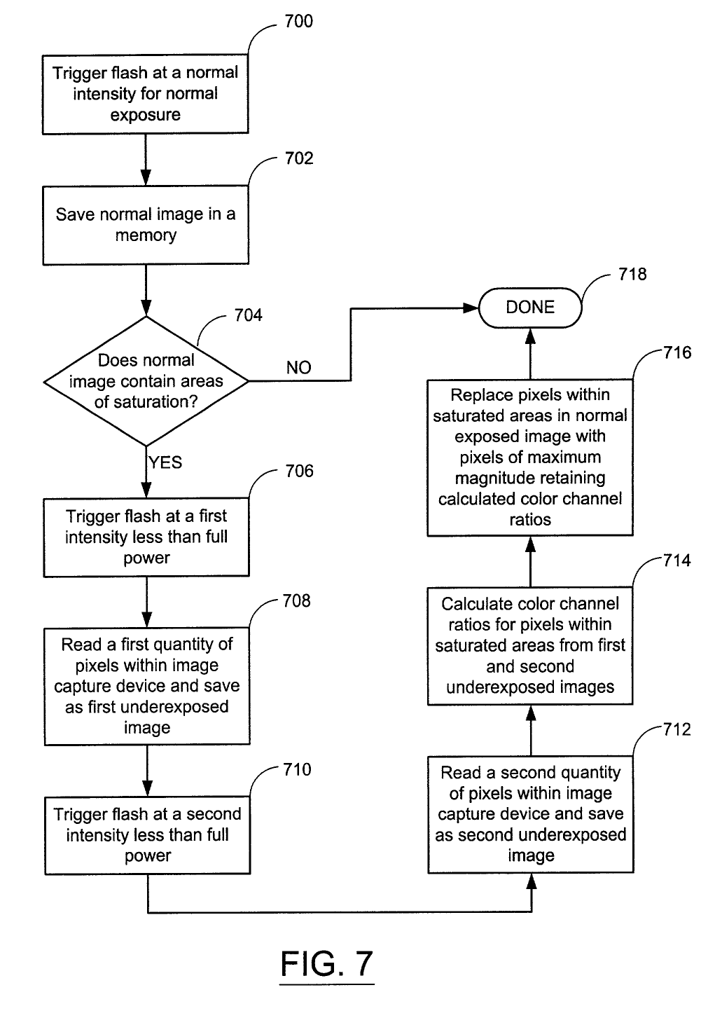

Note that some embodiments of the present invention may take the underexposed image or images after taking the normal exposure. This allows the image capture device to examine the normal exposure for areas of saturation before taking the underexposed image or images. If there are no areas of saturation within the normal images there is no need for any underexposed images to be taken. Three example embodiments of methods according to the present invention using this technique are shown in FIGS. 7 through 9.

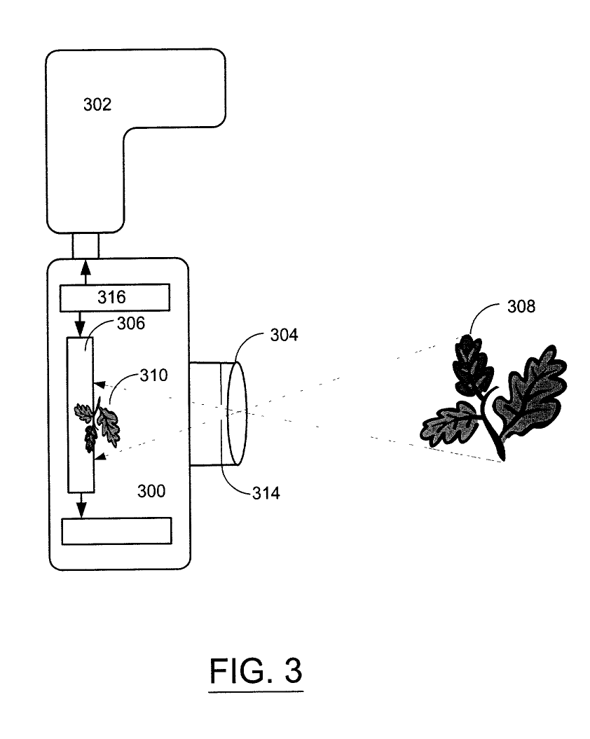

FIG. 3 is an example embodiment of an image capture device according to the present invention. An image capture device 300 such as a digital camera is aimed at an object 308. The image capture device 300 includes a lens 304 that forms an image 310 of the object 308 on a sensor 306 such as a CCD array. In response to commands by a controller 316, the sensor 306 stores image information in a memory 312. A flash 302, triggered by the controller 316, may be used to illuminate the image and to produce illumination of varying intensities to enable the capture of one or more underexposure. The exposure may also be varied by changing the aperture 314 of the lens 304 or the exposure time of the image capture device 300.

FIG. 4 is a flowchart of an example embodiment of a method for reducing glare according to the present invention. In a step 400, a flash 302 is triggered by a controller 316 to fire at a first intensity that is less than the intensity required for a normal exposure. In a step 402, a first quantity of pixels within the image capture device is read and saved in a memory as a first underexposed image. In an optional step 404, a flash 302 is triggered to fire at a second intensity that is less than the intensity required for a normal exposure. This second optional underexposure may be desired if in the first underexposed image, there are saturated pixels. A second exposure may them be taken at a shorter exposure in an attempt to capture color information from those pixels that were saturated in the first underexposure. Note that some areas of an image may remain saturated in all of the underexposures, and in an example embodiment of the present invention, those areas may be left saturated in the final image. In an optional step 406, a second quantity of pixels within the image capture device is read and saved in a memory as a second underexposed image. Any number of underexposed images may be taken within the scope of the present invention. Also the quantity of pixels sampled may vary within the scope of the present invention. The embodiments of the present invention shown in FIGS. 1 and 2 sample about 25% of the pixels available in the CCD array, however, other fractions (including sampling all of the pixels) may be used within the scope of the present invention. In a step 408, a flash 302 is triggered to fire at the intensity required for a normal exposure. In a step 410, a third quantity of pixels within the image capture device is read and saved in a memory as a normal exposed image.

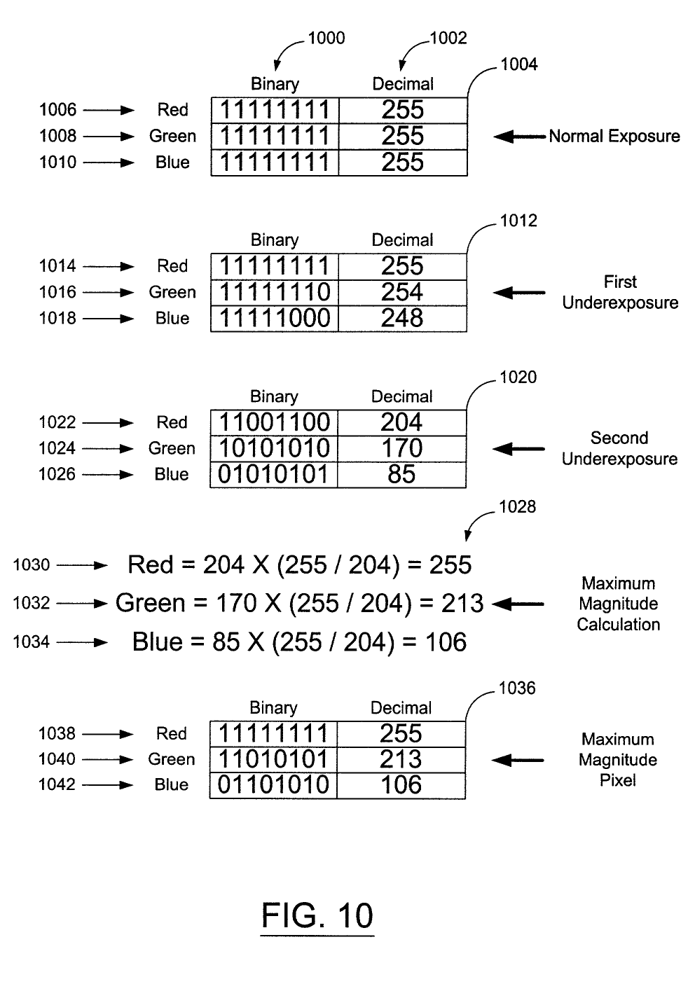

In a step 412, saturated areas are detected within the normal exposed image using techniques well known to those of skill in the art. In a step 414, color channel ratios are calculated for pixels within the areas of saturation from the color information stored in the underexposed images. Finally, in a step 416, pixels within areas of saturation in the normal exposed image are replaced with pixels of maximum magnitude while retaining the color channel ratios calculated in step 414. An example embodiment of a method of calculating pixels of maximum magnitude retaining color channel ratios according to the present invention is shown in FIG. 10.

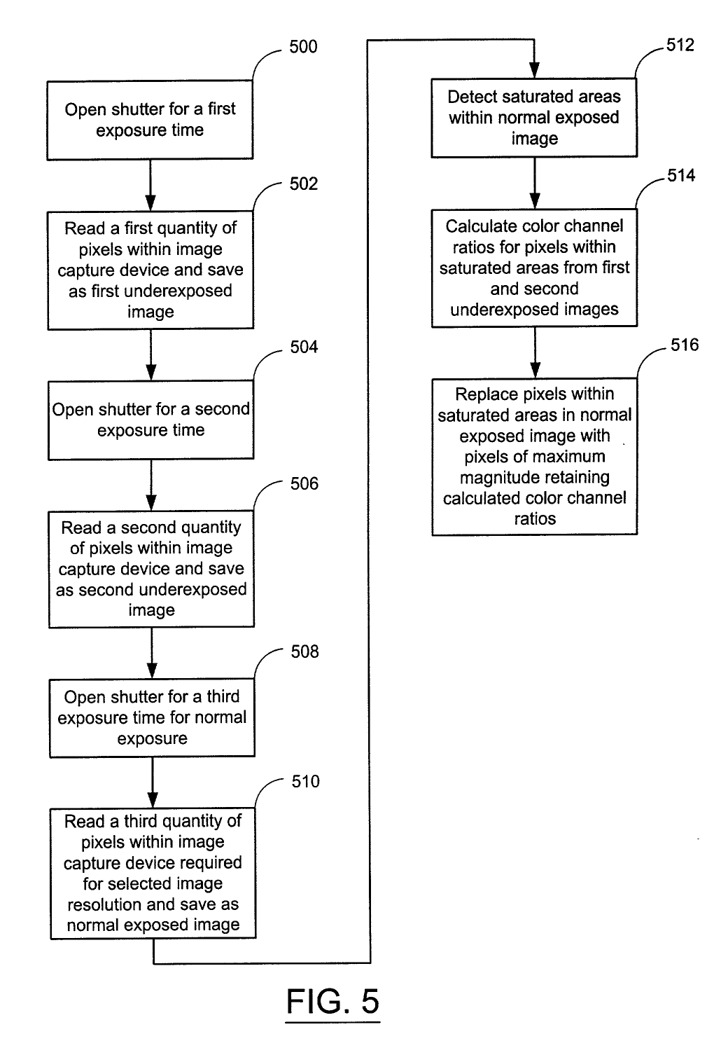

FIG. 5 is a flowchart of an example embodiment of a method for reducing glare according to the present invention. The example embodiment of the present invention shown in FIG. 5 is similar to that of FIG. 4 with the exception, that instead of varying flash intensity to produce underexposures, exposure time is varied. In a step 500, an image capture device makes a first underexposure for a first exposure time less than that required for a normal exposure. Note that this exposure time may be referred to as a shutter speed, however, not all image capture devices contain mechanical shutters, and instead clock the CCD array for an exposure time equivalent to a shutter speed. In a step 502, a first quantity of pixels within the image capture device is read and saved in a memory as a first underexposed image. In an optional step 504, an image capture device makes a second underexposure for a second exposure time less than that required for a normal exposure. In an optional step 506, a second quantity of pixels within the image capture device is read and saved in a memory as a second underexposed image. Any number of underexposed images may be taken within the scope of the present invention. Also the quantity of pixels sampled may vary within the scope of the present invention. The embodiments of the present invention shown in FIGS. 1 and 2 sample about 25% of the pixels available in the CCD array, however, other fractions (including sampling all of the pixels) may be used within the scope of the present invention. In a step 508, an image capture device makes an exposure for the time required for a normal exposure. In a step 510, a third quantity of pixels within the image capture device is read and saved in a memory as a normal exposed image.

In a step 512, saturated areas are detected within the normal exposed image using techniques well known to those of skill in the art. In a step 514, color channel ratios are calculated for pixels within the areas of saturation from the color information stored in the underexposed images. Finally, in a step 516, pixels within areas of saturation in the normal exposed image are replaced with pixels of maximum magnitude while retaining the color channel ratios calculated in step 514.

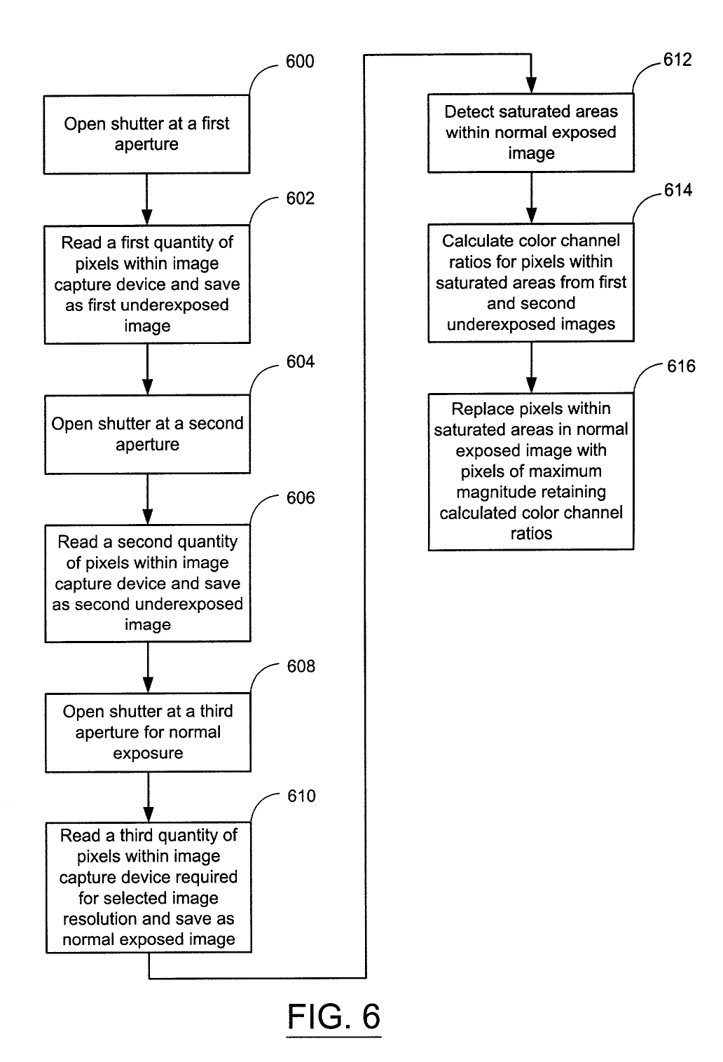

FIG. 6 is a flowchart of an example embodiment of a method for reducing glare according to the present invention. The example embodiment of the present invention shown in FIG. 6 is similar to that of FIG. 4 with the exception, that instead of varying flash intensity to produce underexposures, lens aperture is varied. In a step 600, an image capture device makes a first underexposure at an aperture smaller than that required for a normal exposure. In a step 602, a first quantity of pixels within the image capture device is read and saved in a memory as a first underexposed image. In an optional step 604, an image capture device makes a second underexposure at an aperture smaller than that required for a normal exposure. In an optional step 606, a second quantity of pixels within the image capture device is read and saved in a memory as a second underexposed image. Any number of underexposed images may be taken within the scope of the present invention. Also the quantity of pixels sampled may vary within the scope of the present invention. The embodiments of the present invention shown in FIGS. 1 and 2 sample about 25% of the pixels available in the CCD array, however, other fractions (including sampling all of the pixels) may be used within the scope of the present invention. Use of fractions of the pixels in the CCD array allows for faster processing of the pixel data at the loss of some resolution. When fewer than all of the pixels are used, the color value for unselected pixels may be calculated by interpolation between nearby selected pixels. This causes some loss of resolution in the areas of saturation within the final image, however, even such a process generates more accurate coloration of those areas than if they were left saturated. In a step 608, an image capture device makes an exposure at the aperture required for a normal exposure. In a step 610, a third quantity of pixels within the image capture device is read and saved in a memory as a normal exposed image.

In a step 612, saturated areas are detected within the normal exposed image using techniques well known to those of skill in the art. In a step 614, color channel ratios are calculated for pixels within the areas of saturation from the color information stored in the underexposed images. Finally, in a step 616, pixels within areas of saturation in the normal exposed image are replaced with pixels of maximum magnitude while retaining the color channel ratios calculated in step 614.

FIG. 7 is a flowchart of an example embodiment of a method for reducing glare according to the present invention. The example embodiment of the present invention shown in FIG. 7 is similar to that of FIG. 4 with the exception, that a normal exposure is taken first, then examined for areas of saturation and the under exposures are only taken if needed. In a step 700, a flash 302 is triggered at a normal intensity to produce a normal exposure. In a step 702, the normal image produced by the normal exposure is saved in a memory. In a decision step 704, the normal image is examined to find areas of saturation. If no areas of saturation are found, the normal image does not need further glare reduction and the method stops in a step 718. If areas of saturation are found within the normal image, in a step 706, a flash 302 is triggered to fire at a first intensity that is less than the intensity required for a normal exposure. In a step 708, a first quantity of pixels within the image capture device is read and saved in a memory as a first underexposed image. In an optional step 710, a flash 302 is triggered to fire at a second intensity that is less than the intensity required for a normal exposure. In an optional step 712, a second quantity of pixels within the image capture device is read and saved in a memory as a second underexposed image. Any number of underexposed images may be taken within the scope of the present invention. Also the quantity of pixels sampled may vary within the scope of the present invention. The embodiments of the present invention shown in FIGS. 1 and 2 sample about 25% of the pixels available in the CCD array, however, other fractions (including sampling all of the pixels) may be used within the scope of the present invention.

In a step 714, color channel ratios are calculated for pixels within the areas of saturation from the color information stored in the underexposed images. Finally, in a step 716, pixels within areas of saturation in the normal exposed image are replaced with pixels of maximum magnitude while retaining the color channel ratios calculated in step 714 and the process ends in a step 718.

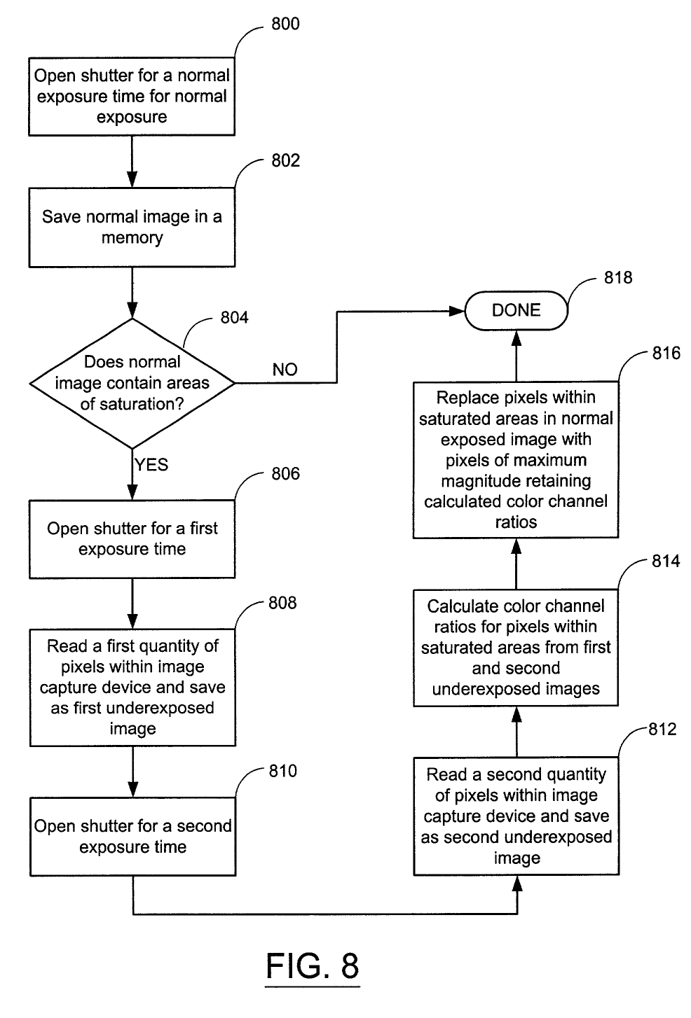

FIG. 8 is a flowchart of an example embodiment of a method for reducing glare according to the present invention. The example embodiment of the present invention shown in FIG. 8 is similar to that of FIG. 7 with the exception, that instead of varying flash intensity to produce underexposures, exposure time is varied. In a step 800, an image capture device makes an exposure for an exposure time equal to that required for a normal exposure. In a step 802, the normal image produced by the normal exposure is saved in a memory. In a decision step 804, the normal image is examined to find areas of saturation. If no areas of saturation are found, the normal image does not need further glare reduction and the method stops in a step 818. If areas of saturation are found within the normal image, in a step 806, an image capture device makes a first underexposure for an first exposure time less than that required for a normal exposure. Note that this exposure time may be referred to as a shutter speed, however, not all image capture devices contain mechanical shutters, and instead clock the CCD array for an exposure time equivalent to a shutter speed. In a step 808, a first quantity of pixels within the image capture device is read and saved in a memory as a first underexposed image. In an optional step 810, an image capture device makes a second underexposure for a second exposure time less than that required for a normal exposure. In an optional step 812, a second quantity of pixels within the image capture device is read and saved in a memory as a second underexposed image. Any number of underexposed images may be taken within the scope of the present invention. Also the quantity of pixels sampled may vary within the scope of the present invention. The embodiments of the present invention shown in FIGS. 1 and 2 sample about 25% of the pixels available in the CCD array, however, other fractions (including sampling all of the pixels) may be used within the scope of the present invention.

In a step 814, color channel ratios are calculated for pixels within the areas of saturation from the color information stored in the underexposed images. Finally, in a step 816, pixels within areas of saturation in the normal exposed image are replaced with pixels of maximum magnitude while retaining the color channel ratios calculated in step 814 and the process ends in a step 818.

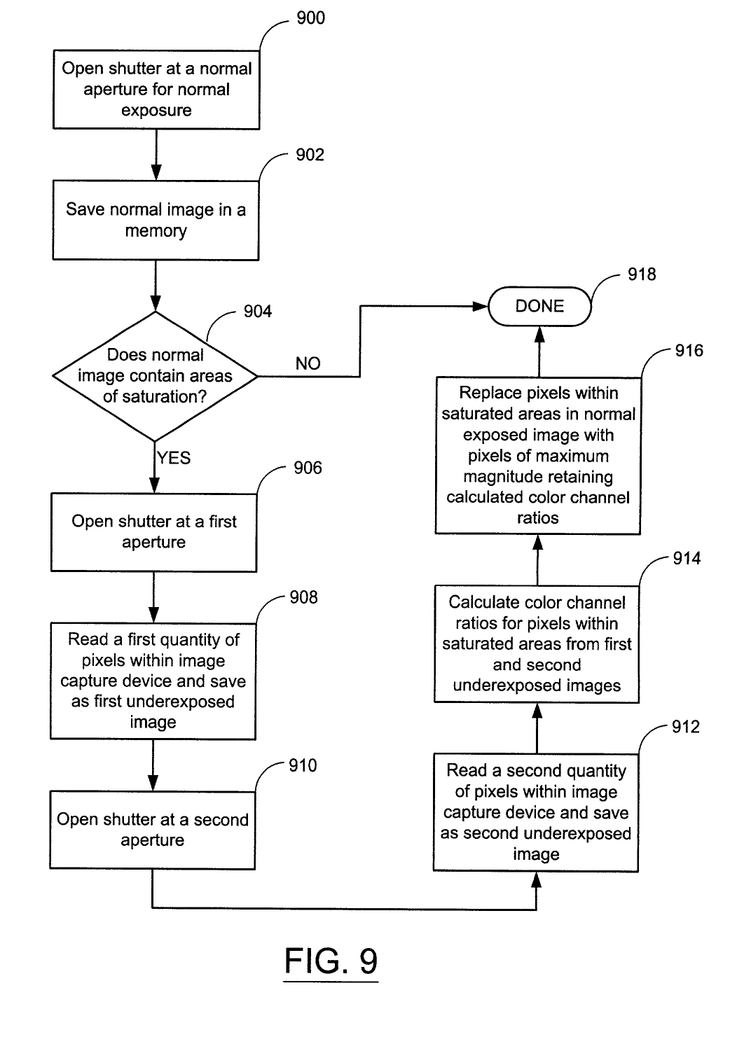

FIG. 9 is a flowchart of an example embodiment of a method for reducing glare according to the present invention. The example embodiment of the present invention shown in FIG. 9 is similar to that of FIG. 7 with the exception, that instead of varying flash intensity to produce underexposures, lens aperture is varied. In a step 900, an image capture device makes an exposure at an aperture equal to that required for a normal exposure. In a step 902, the normal image produced by the normal exposure is saved in a memory. In a decision step 904, the normal image is examined to find areas of saturation. If no areas of saturation are found, the normal image does not need further glare reduction and the method stops in a step 918. If areas of saturation are found within the normal image, in a step 906, an image capture device makes a first underexposure at a first aperture smaller than that required for a normal exposure. In a step 908, a first quantity of pixels within the image capture device is read and saved in a memory as a first underexposed image. In an optional step 910, an image capture device makes a second underexposure at a second aperture smaller than that required for a normal exposure. In an optional step 912, a second quantity of pixels within the image capture device is read and saved in a memory as a second underexposed image. Any number of underexposed images may be taken within the scope of the present invention. Also the quantity of pixels sampled may vary within the scope of the present invention. The embodiments of the present invention shown in FIGS. 1 and 2 sample about 25% of the pixels available in the CCD array, however, other fractions (including sampling all of the pixels) may be used within the scope of the present invention.

In a step 914, color channel ratios are calculated for pixels within the areas of saturation from the color information stored in the underexposed images. Finally, in a step 916, pixels within areas of saturation in the normal exposed image are replaced with pixels of maximum magnitude while retaining the color channel ratios calculated in step 914 and the process ends in a step 918.

FIG. 10 is an example calculation of a maximum color magnitude while retaining color channel ratios in an example embodiment of the present invention. In the example calculation shown in FIG. 10 a pixel containing eight bits each of red, green, and blue intensity data is used. In other embodiments of the present invention, different color spaces and pixel resolutions may be used following similar methods within the scope of the present invention. A saturated normal exposure pixel 1004 contains saturated red data 1006, saturated green data 1008, and saturated blue data 1010 for the single pixel. This pixel data is shown in binary 1000 and decimal 1002 representations for ease of understanding. In the case of a saturated pixel, the saturated red data 1006 is equal to ‘11111111’ in binary, or ‘255’ in decimal notation. This is the largest intensity value possible in an eight-bit red color channel. The saturated green data 1008 is equal to ‘11111111’ in binary, or ‘255’ in decimal notation, while the saturated blue data 1010 is equal to ‘11111111’ in binary, or ‘255’ in decimal notation. In an example first underexposure 1012, the green and blue channels are no longer saturated, however, the red channel is still saturated. The first underexposure red data 1014 is still equal to ‘11111111’ in binary, or ‘255’ in decimal notation. The first underexposure green data 1016 is equal to ‘11111110’ in binary, or ‘254’ in decimal notation, showing an intensity just one bit short of saturation. The first underexposure blue data 1018 is equal to ‘11111000’ in binary, or ‘248’ in decimal notation in this example exposure. Since the red channel is still saturated in the first underexposure, in some example embodiments of the present invention, a second underexposure 1020 may be taken with an exposure less than that of the first underexposure 1012. In this example second underexposure 1020 none of the color channels remain saturated. The second underexposure red data 1022 is equal to ‘11001100’ in binary, or ‘204’ in decimal notation. The second underexposure green data 1024 is equal to ‘10101010’ in binary, or ‘170’ in decimal notation. The second underexposure blue data 1026 is equal to ‘01010101’ in binary, or ‘85’ in decimal notation. Thus the red:green:blue color channel ratio for this pixel is 204:170:85. To calculate the value of a maximum magnitude pixel retaining this color channel ratio, the saturated value of a color channel (in this example ‘255’) is divided by the value most saturated color channel (in this example the red color channel at ‘204’). This ratio is used to offset the remaining color channels in a maximum magnitude calculation 1028. The red channel calculation 1030 multiplies the value of the red channel from the underexposure (‘204’) by 255/204 producing a final value of ‘255’ or saturation of the red channel. The green channel calculation 1032 multiplies the value of the green channel from the underexposure (‘170’) by 255/204 producing a final value of ‘213’. The blue channel calculation 1034 multiplies the value of the blue channel from the underexposure (‘85’) by 255/204 producing a final value of ‘106’. These final values maintain the color channel ration of 204:170:85 in a pixel of maximum magnitude 1036. In a pixel of maximum magnitude 1036, the maximum magnitude red data 1038 is equal to ‘11111111’ in binary, or ‘255’ in decimal notation. The maximum magnitude green data 1040 is equal to ‘11010101’ in binary, or ‘213’ in decimal notation. The maximum magnitude blue data 1042 is equal to ‘01101010’ in binary, or ‘106’ in decimal notation.

The foregoing description of the present invention has been presented for purposes of illustration and description. It is not intended to be exhaustive or to limit the invention to the precise form disclosed, and other modifications and variations may be possible in light of the above teachings. The embodiments were chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method for the reduction of glare by an image capture device comprising the steps of:
a) capturing at least one underexposed image;
b) capturing a normal exposed image;
c) detecting areas of saturation within said normal exposed image;
d) calculating color channel ratios for pixels within said areas of saturation from corresponding pixels within said at least one underexposed image; and
e) replacing saturated pixels within said normal exposed image with pixels of maximum magnitude with said calculated color channel ratios.

2. The method for the reduction of glare by an image capture device as recited in claim 1 further comprising the steps of:
f) capturing a second underexposed image; and
g) calculating color channel ratios for pixels within said areas of saturation from corresponding pixels within said first and second underexposed images.

3. The method for the reduction of glare by an image capture device as recited in claim 1; wherein said at least one underexposed image is captured at a resolution less than that of said normal exposed image.

4. The method for the reduction of glare by an image capture device as recited in claim 1; wherein said at least one underexposed image is created by triggering a flash at an intensity less than that required for a normal exposure.

5. The method for the reduction of glare by an image capture device as recited in claim 1; wherein said at least one underexposed image is created by the use of an exposure time less than that required for a normal exposure.

6. The method for the reduction of glare by an image capture device as recited in claim 1; wherein said at least one underexposed image is created by the use of an aperture less than that required for a normal exposure.

7. A method for the reduction of glare by an image capture device comprising the steps of:
a) capturing a normal exposed image;
b) detecting areas of saturation within said normal exposed image; and
c) when areas of saturation are detected, performing the sub-steps of:
i) capturing at least one underexposed image;
ii) calculating color channel ratios for pixels within said areas of saturation from corresponding pixels within said at least one underexposed image; and
iii) replacing saturated pixels within said normal exposed image with pixels of maximum magnitude with said calculated color channel ratios.

8. The method for the reduction of glare by an image capture device as recited in claim 1 further comprising the sub-steps of:
iv) capturing a second underexposed image; and
v) calculating color channel ratios for pixels within said areas of saturation from corresponding pixels within said first and second underexposed images.

9. The method for the reduction of glare by an image capture device as recited in claim 7; wherein said at least one underexposed image is captured at a resolution less than that of said normal exposed image.

10. The method for the reduction of glare by an image capture device as recited in claim 7; wherein said at least one underexposed image is created by triggering a flash at an intensity less than that required for a normal exposure.

11. The method for the reduction of glare by an image capture device as recited in claim 7; wherein said at least one underexposed image is created by the use of an exposure time less than that required for a normal exposure.

12. The method for the reduction of glare by an image capture device as recited in claim 7; wherein said at least one underexposed image is created by the use of an aperture less than that required for a normal exposure.

13. A digital image capture device comprising:
a body;
a CCD array mechanically coupled within said body; and
a controller mechanically coupled within said body and electrically coupled with said CCD array;
wherein said controller is configured to:
a) capture a normal exposed image in said CCD array;
b) detect areas of saturation within said normal exposed image;
c) capture at least one underexposed image in said CCD array;
d) calculate color channel ratios for pixels within said areas of saturation from corresponding pixels within said underexposed image; and
e) replace saturated pixels within said normal exposed image with pixels of maximum saturation with said calculated color channel ratios.

14. The digital image capture device recited in claim 13, further comprising:
a flash mechanically coupled with said body and electrically coupled with said controller.

15. A digital image capture device comprising:
means for capturing at least one underexposed image;
means for capturing a normal exposed image;
means for detecting areas of saturation within said normal exposed image;
means for calculating color channel ratios for pixels within said areas of saturation from corresponding pixels within said at least one underexposed image; and
means for replacing saturated pixels within said normal exposed image with pixels of maximum magnitude with said calculated color channel ratios.

16. The digital image capture device recited in claim 15; wherein said at least one underexposed image is captured at a resolution less than that of said normal exposed image.

17. The digital image capture device recited in claim 15; wherein said means for capturing at least one underexposed image includes means for triggering a flash at an intensity less than that required for a normal exposure.

18. The digital image capture device recited in claim 15; wherein said means for capturing at least one underexposed image includes means for creating an exposure time less than that required for a normal exposure.

19. The digital image capture device recited in claim 15; wherein said means for capturing at least one underexposed image includes means for creating an aperture less than that required for a normal exposure.
